(19) United States
(12) Patent Application Publication
(10) Pub. No.: US 2020/0234244 A1
(43) Pub. Date: Jul. 23, 2020

(54) PROVIDING LIMITED PERMISSION LEVEL FUNCTIONALITY FOR LISTINGS IN A NETWORK

(71) Applicants: Li Zhou, Sunnyvale, CA (US); Chong Zhang, Mountain View, CA (US); Andrew Walter Chimka, San Francisco, CA (US); Kevin Chuang, San Francisco, CA (US); Kumaresh Pattabiraman, Sunnyvale, CA (US); Yixiao Lu, San Jose, CA (US); Chen Qian, Fremont, CA (US); George Pearman, Menlo Park, CA (US)

(72) Inventors: Li Zhou, Sunnyvale, CA (US); Chong Zhang, Mountain View, CA (US); Andrew Walter Chimka, San Francisco, CA (US); Kevin Chuang, San Francisco, CA (US); Kumaresh Pattabiraman, Sunnyvale, CA (US); Yixiao Lu, San Jose, CA (US); Chen Qian, Fremont, CA (US); George Pearman, Menlo Park, CA (US)

(21) Appl. No.: 16/255,195

(22) Filed: Jan. 23, 2019

(51) Int. Cl. G06Q 10/10

(52) U.S. Cl. CPC G06Q 10/1053; G06Q 10/107

(57) ABSTRACT

Disclosed are systems, methods, and non-transitory computer-readable media for providing profiles with limited permission level functionality in the network. In response to receiving a request to post the new employment listing, a collaboration system updates a permission list of the employment listing to provide a first user account with an administrator permission level in relation to the employment listing. The administrator permission level provides a first function and a second function in relation to the employment listing. The collaboration system receives a request to tag a second user account to the employment listing and updates the permission list to provide the second user account with a limited permission level in relation to the employment listing. The limited permission level provides the second user account with permission to perform the first function in relation to the employment listing but does not provide permission to perform the second function.

### TECHNICAL FIELD

An embodiment of the present subject matter relates generally to accounts in a network and, more specifically, to providing accounts with limited permission level functionality in the network.

### BACKGROUND

Online services allow users to connect with other users for purposes of networking. For example, users create user accounts that list the users' experience, interests, etc. The completed user accounts can be used to learn about the users, which is helpful in finding candidates for open employment listings. Hiring is often a team based collaborative process, however current systems do not provide shared functionality for multiple users. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system configuration, wherein electronic devices communicate via a network for purposes of exchanging content and other data.

FIG. 2. is a block diagram of a collaboration system, according to some example embodiments.

FIG. 3 is a block diagram of a permission management module, according to some example embodiments.

FIG. 4 is a flowchart showing an example method of initializing permissions levels for an employment listing, according to certain example embodiments.

FIG. 5 is a flowchart showing an example method of tagging a user account to an employment listing, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for providing accounts with limited permission level functionality for listings in the network. A collaboration system provides functionality that enables multiple user accounts to collaborate in relation to an employment listing posted to an online service. An employment listing is a description of an available employment position with an organization (e.g., company). The collaboration system provides a collaboration interface in which designated users may manage the process of filling the available employment position described by the employment listing. For example, the collaboration interface provides the designated users with functionality to suggest candidate user accounts, track the progress of candidate user accounts that have applied and/or are being considered for the available employment position, provide comments regarding candidate user accounts, chat with the other designated user, provide job insights, etc.

The collaboration interface provides varying permission levels in relation to an employment listing. Each permission level grants user accounts access to differing sets of functionalities in relation to the employment listing. For example, the collaboration interface may grant a user account that initially generated an employment listing and/or was identified during generation of the employment listing an administrator permission level that provides the user account with a complete set of functionalities with respect to the employment listing. A complete set of functionalities includes each available function that is available to a user account that is granted adequate permission, such as the varying functions of the collaboration interface (e.g., commenting, messaging, suggesting candidates, provide job insights, etc.). The administrator permission level further allows the user account to tag other user accounts to the employment listing, thereby providing the tagged user accounts with a limited permission level in relation to the employment listing. The limited permission level provides the user accounts with a subset of the complete set of functionalities that are granted by the administrator permission level. For example, the limited permission level may allow the user account to view candidate user accounts for the employment listing and provide feedback on the candidate user account, but not provide other functionality such as tagging other user accounts to the employment listing or editing the employment listing. The collaboration interface allows a group of users (e.g., a hiring team) to collaborate during the process of filling the available employment position, while maintaining ownership of the employment listing with the designated administrator user account. This provides an improvement in the relevant technology by allowing for managed and varied permission levels in relation to a listing. Current systems do not allow this functionality, which limits the collaboration process to fewer users or grants too high of a permission level to some users. By providing the varying permission levels, multiple users may collaborate on a single posting and proper permission levels may be maintained with select users.

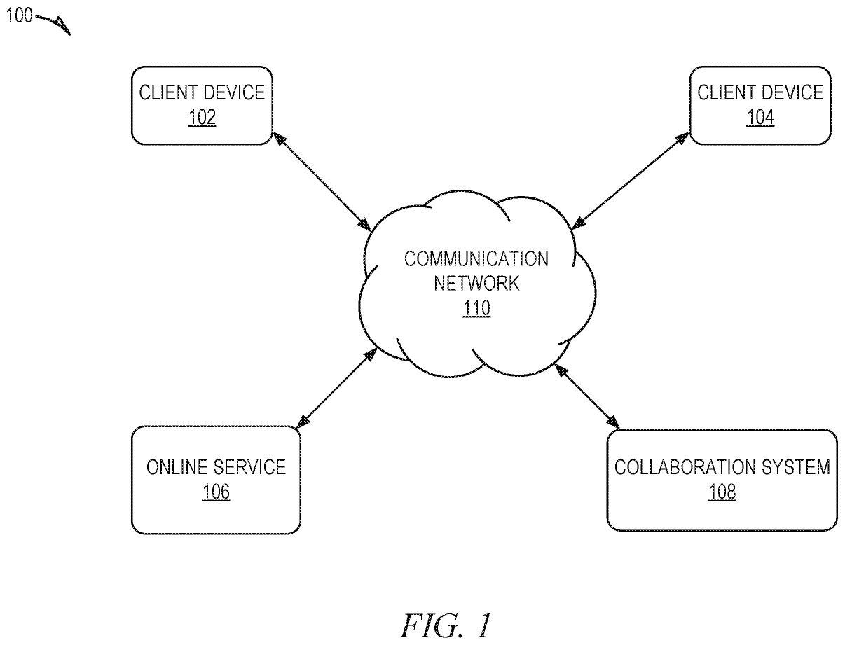

FIG. 1 shows an example system 100, wherein electronic devices communicate via a network for purposes of exchanging content and other data. As shown, multiple devices (i.e., client device 102, client device 104, online service 106, and collaboration system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

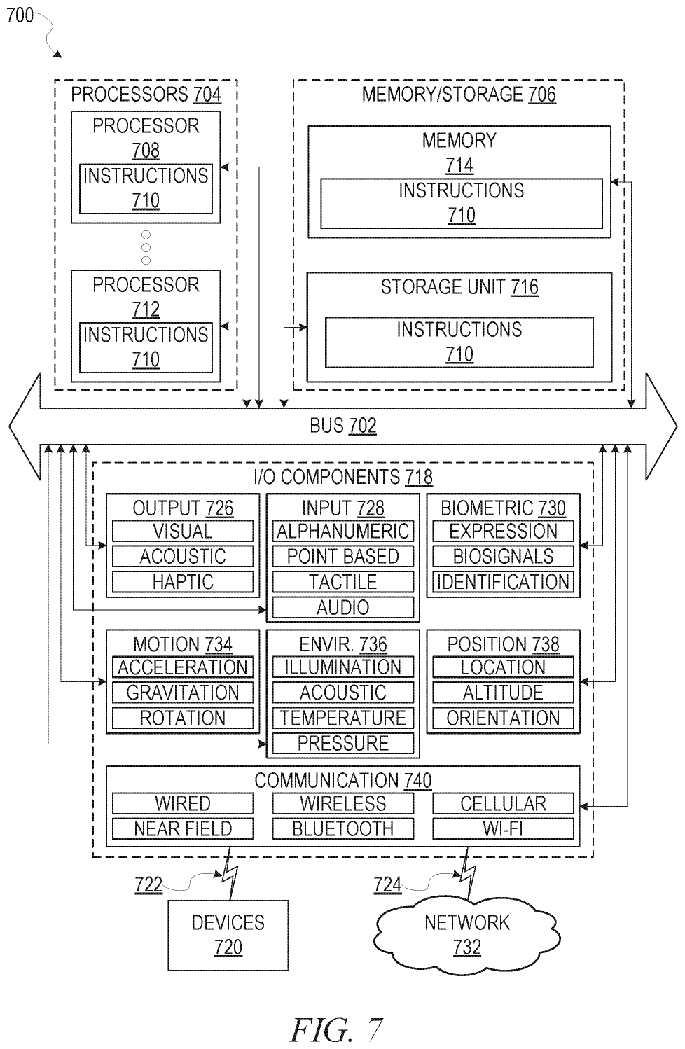

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online service 106 to utilize the services provided by the online service 106. Users communicate with and utilize the functionality of the online service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online service 106 may concurrently accept connections from and interact with any number of client devices 102, 104. The online service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online service 106 via a client-side application installed on the client devices 102 and 104. In some embodiments, the client-side application includes a component specific to the online service 106. For example, the component may be a stand-alone application, one or more application plug-ins, and/or a browser extension. However, the users may also interact with the online service 106 via a third-party application, such as a web browser, that resides on the client devices 102 and 104 and is configured to communicate with the online service 106. In either case, the client-side application presents a user interface (UI) for the user to interact with the online service 106. For example, the user interacts with the online service 106 via a client-side application integrated with the file system or via a webpage displayed using a web browser application.

The online service 106 is one or more computing devices configured to provide a social networking service. The online service 106 may provide any type of social networking service that allows a user to create a user account, view the user accounts of other users, make connections with other user accounts, post content and view content posted by other users. An example of a social networking service is LINKEDIN.

A user may include information describing themselves in their user account with the online service 106. For example, the user may include information such as their name, interests, location, job history, skills, goals (e.g., looking to find new opportunities) etc.

A user may also establish connections with other users on the online service 106. For example, the user may send and receive connection request to establish a connection with another user account. Establishing connections allows users to view their connection's user accounts and content posted by their connections.

As part of its provided service, the online service 106 allows organizations (e.g., companies) to post employment listings for available employment positions with the organization. An employment listing is a description of an available employment position at the organization. The employment listing may include the title of the available employment position (e.g., software programmer, project manager, etc.), a description of the responsibilities of the employment position, a description of desired skills of an applicant, a geographic location of the employment position, a salary range, etc. The employment listing may further enable a user to apply for the available employment position by submitting a resume, application, etc.

To post an employment listing, a user that is authorized by the organization (e.g., is an employee of the organization, a contracted recruiter, etc.) uses a client device 102 to login to their user account with the online service 106 and generate the employment listing on the online service 106. For example, the user may provide text describing the open position, such as the title, salary range, desired skills, etc. The user may then post the employment listing, causing the employment listing to be viewable by other users of the online service 106.

The online service 106 enables members of the organization to collaborate in relation to a posted employment listing. For example, the online service 106 uses the functionality of a collaboration system 108, which provides a collaboration interface in which multiple designated users may manage the process of filling the available employment position described by the employment listing. For example, the collaboration interface provides the designated users with functionality to suggest candidate user accounts, track the progress of candidate user accounts that have applied and/or are being considered for the available employment position, provide comments regarding candidate user accounts, provide job insights, chat with the other designated user, etc. Although the collaboration system 108 and the online service 106 are shown as separate entities, this is just one embodiments and is not meant to be limiting. In some embodiments, the collaboration system 108 may be incorporated as part of the online service 106.

The collaboration system 108 is one or more computing device configured to provide functionality that enables multiple user accounts of the online service 106 to collaborate in relation to an employment listing posted by the online service 106. An employment listing is a description of an available employment position with an organization (e.g., company). The collaboration system 108 provides a collaboration interface in which designated users may manage the process of filling the available employment position described by the employment listing. For example, the collaboration interface provides the designated users with functionality to suggest candidate user accounts, track the progress of candidate user accounts that have applied and/or are being considered for the available employment position, provide comments regarding candidate user accounts, provide job insights, chat with the other designated user, etc.

The collaboration interface provides varying permission levels in relation to an employment listing. Each permission level grants user accounts access to differing sets of functionalities in relation to the employment listing. For example, the collaboration interface grants an administrator permission level to a user account that initially generated an employment listing and/or was designated as an administrator during creation of the employment listing. The administrator permission level provides the user account with a complete set of functionalities in relation to the employment listing. The complete set of functions includes the varying functions of the collaboration interface, as well as administrator type functionality, such modifying the employment listing and tagging other user accounts to the employment listing.

Tagging other user accounts to the employment listing provides the tagged user accounts with a limited permission level in relation to the employment listing. The limited permission level provides the user accounts with a subset of the complete set of functionalities that are granted by the administrator permission level. For example, the limited permission level may allow the user account to view candidate user accounts for the employment listing and provide feedback on the candidate user accounts, but not provide other functionality such as tagging other user accounts to the employment listing or editing the employment listing. This allows a group of users to collaborate during the process of filling the available employment position, while retaining administrative control of the process to designated user accounts.

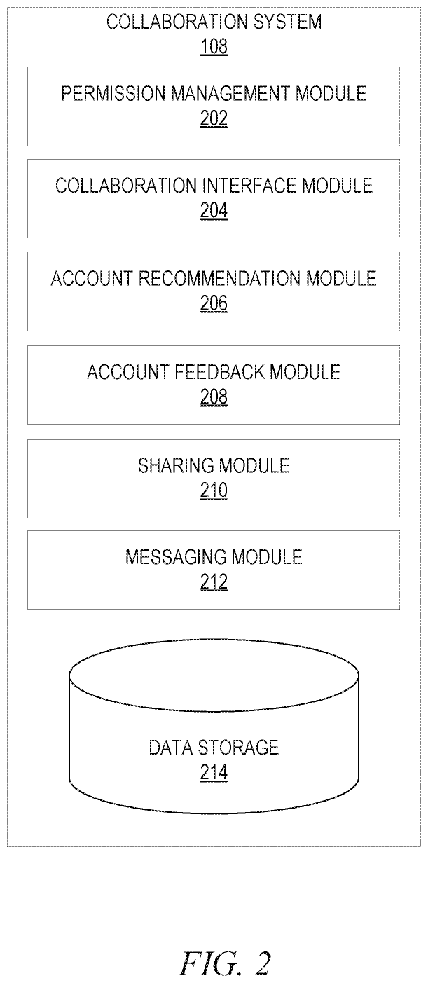

FIG. 2 is a block diagram of a collaboration system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the collaboration system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the collaboration system 108 and the online service 106.

As shown, the collaboration system 108 includes a permission management module 202, a collaboration interface module 204, an account recommendation module 206, an account feedback module 208 a sharing module 210, a messaging module 212, and a data storage 214. As explained earlier, the collaboration system 108 provides functionality that enables multiple user accounts of the online service 106 to collaborate in relation to an employment listing posted to an online service 106. To achieve this, the permission management module 202 manages permission levels for an employment listing. A permission level assigned to a user account dictates what functions the user account can use in relation to the employment listing. For example, the varying permission levels may grant a user account permission to perform the complete set of functions that are available, a subset of the available functions, or none of the functions.

The permission management module 202 maintains a permission list that identifies permission levels of user accounts in relation to an employment listing. The permission list is stored in the data storage 214 and includes unique listing identifiers that identify the employment listings posted to the online service 106. The permission list also includes unique account identifies identifying the user accounts that have been granted permission to perform functionality in relation to the employment listing, as well as data identifying the permission level assigned to each listed user account. For example, the permission list may include a value that identifies the permission level assigned to the user account. As another example, the permission list may include values identifying the specific functions that the user account has been assigned permission to perform.

The permission management module 202 accesses the permission list from the data storage 214 to initialize and modify permission levels for an employment listing. For example, the permission management module 202 accesses the permission list from the data storage 214 to add the unique listing identifier for a newly generated employment listing. The permission management module 202 further assigns initial permission levels to one or more user accounts in relation to the employment listing. For example, the permission management module 202 may assign the user account used to generate the employment listing an administrator permission level in relation to the employment listing.

As another example, the permission management module 202 may assign initial permission levels based on selections made during creation of the employment listing. For example, a user may be prompted, during the process of generating an employment listing, to select user accounts that are to be granted permission to perform functions in relation to the employment listing, as well as the permission level that should be granted to each user account. Accordingly, a user creating the employment listing selects user accounts that should be assigned with an administrator permission level or a limited permission level. The selections made by the user are used by the permission management module 202 to assign the initial permission levels for the employment listing.

A user that has been granted permission to tag other user accounts and/or otherwise change the permission levels for the employment listing may then later modify the initial permission levels. For example, the user may use the collaboration interface to select to tag additional user accounts, un-tag a user account (e.g., remove the limited permission level granted to a user account), assign a user account as an administrator, etc. While the examples of an administrator permission level and a limited permission level are used, these are just two examples and are not meant to be limiting. The collaboration system 108 may use any number of permission levels.

The permission management module 202 also confirms the permission level of a user account. For example, the permission management module 202 may receive requests to determine the permission level of a user account. The request may include the account identifier identifying the user account and the listing identifier identifying the employment listing. The permission management module 202 uses the included identifiers to search the permission list and determine the permission level of the user account.

The collaboration interface module 204 provides a collaboration interface that allows user accounts to collaborate in relation to an employment listing. For example, the collaboration interface provides user interface elements, such as buttons, text fields, etc., that the users may use to utilize the provided functionality of the collaboration interface. The collaboration interface module 204 provides functionality to a user based on the permission level assigned to the user's account. For example, the collaboration interface module 204 may request the permission level of a user account from the permission management module 202 prior to making functionality available to a user account. The collaboration interface module 204 may limit the functionality presented to the user in relation to an employment listing based on the determined permission level of the user account. For example, the collaboration interface module 204 may present user interface elements for functions that the user is permitted to perform, and not present user interface elements for functions that the user is not permitted to perform.

The collaboration interface module 204 may provide any number of functions, such as allowing users to view an employment listing, modify the employment listing, recommend the employment listing to users, view candidates that have applied to the employment listing, comment on candidates, message with other collaborating user accounts, etc. These are just a few examples and not meant to be limiting. Some of these features are discussed in greater detail below.

The account recommendation module 206 enables authorized user accounts to recommend user accounts for an employment listing. For example, the account recommendation module 206 enables a user to enter data identifying user accounts that the user would like to recommend for the employment listing. Upon receiving the data, the account recommendation module 206 may add the recommended user accounts to a list that is available to be reviewed by the other collaborating users of the employment listing. As another example, the account recommendation module 206 transmits a notification to the other collaborating users that identifies the recommended user accounts. In either case, the list or the notification may include data pulled from the recommended user account, such as the user's name, experience, etc., as well as a link to access the user account.

The account feedback module 208 enables authorized users to provide feedback in relation to a candidate user account. For example, the account feedback module 208 enables users to provide a ranking, scores, written comments, etc., in relation to a candidate user profile. The provided feedback is accessible to the other collaborating users and may be used in evaluating a candidate.

The sharing module 210 may enable a collaborating user to share the employment listing to a desired user account. For example, the user enters data identifying the user account. The sharing module 210 uses the data to transmit a notification to the user account that describes the employment listing and/or includes a link to the employment listing.

The messaging module 212 enables the collaborating users to engage in a communication session with each other. A communication session is a communication interface, such as an instant messenger, chatroom, etc., that allows the users to enter messages that are received by the other collaborating users. The collaborating users can use the communication session to share ideas, thoughts, etc., in relation to an employment listing.

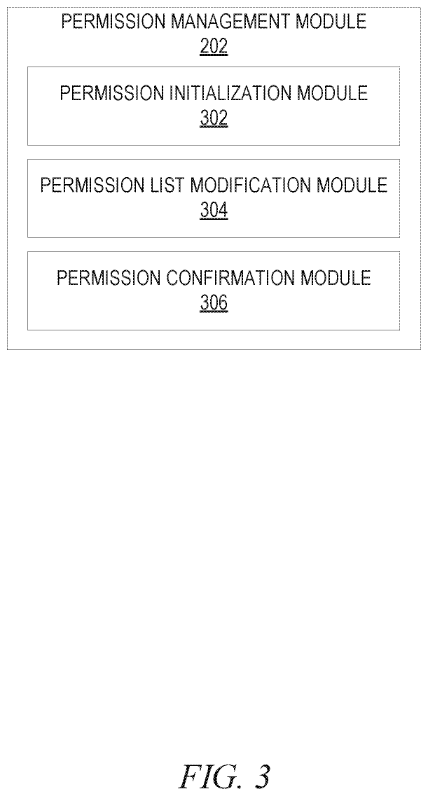

FIG. 3 is a block diagram of a permission management module 202, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the permission management module 202 to facilitate additional functionality that is not specifically described herein. Furthermore, the various functional modules depicted in FIG. 3 may reside on a single computing device or may be distributed across several computing devices in various arrangements such as those used in cloud-based architectures. For example, the various functional modules and components may be distributed amongst computing devices that facilitate both the collaboration system 108 and the online service 106.

As shown, the permission management module 202 includes a permission initialization module 302, a permission list modification module 304 and a permission confirmation module 306. As explained above, the permission management module 202 manages permission levels for an employment listing.

The permission initialization module 302 initializes permission levels for a newly generated employment listing. The permission management module 202 receives input from the online service that notifies the permission management module 202 that a new employment listing has been generated and/or posted to the online service 106. The input includes data identifying the newly generated employment listing, such as a unique listing identifier generated by the online service 106 for the new employment listing. The received input may also include data identifying the user account used to generate the employment listing. For example, the input may receive the unique account identifier for the user account.

The input may also receive data describing selected initial permission levels for the employment listing. The online service 106 may allow a user to select user accounts and corresponding permission levels for the user accounts during creation of an employment listing. Accordingly, a user generating an employment listing may designate one or more user accounts to be assigned with administrator permission level for the employment listing, as well as designate one or more user account with limited permission level for the employment listing. The input includes the account identifiers for each of these designated user accounts as well as values indicating the permission level and/or specific functionality granted to each user account.

The permission initialization module 302 uses the data included in the input to modify the permission list to initialize permission levels for the employment listing. For example, the permission initialization module 302 accesses the permission list for the data storage 214 and updates the permission list to include the unique listing identifier for the newly generated employment listing. The permission initialization module 302 then adds the account identifiers and the corresponding permission levels to the permission list and associates them with the unique listing identifier. For example, the permission initialization module 302 uses the initial permission levels received in the input to set the permission levels for the employment listing. In embodiments in which the input does not include the initial permission levels (e.g., the initial permission levels were not selected during generation of the employment listing), the permission initialization module 302 may designate the user account that generated the employment listing as the administrator. That is, the permission initialization module 302 adds the unique account identifier for the user account to the permission listing along with a value indicating that the user account is granted administrator permission level.

The permission list modification module 304 modifies the permission list for an employment listing. For example, an authorized user may wish to tag additional user accounts to the employment listing. This results in a request being transmitted to the permission management module 202. The request includes data identifying the user account and the employment listing. The permission list modification module 304 uses the included data (e.g., account identifier and listing identifier) to search the permission list and modify it accordingly. Tagging a user account results in the user account being granted a limited permission level for the employment listing. The permission list modification module 304 may also modify the permission list to provide an administrator permission level to a user account.

As another example, the permission list modification module 304 may also remove or reduce the permission level assigned to a user account. For example, the permission list modification module 304 may modify the permission list to change the permission level assigned to a user account from an administrator permission level to a limited permission level, or from a limited permission level to no granted permissions.

The permission confirmation module 306 confirms the permission level assigned to a user account. For example, the permission confirmation module 306 may receive requests to determine the permission level of a user account. The request may include the account identifier identifying the user account and the listing identifier identifying the employment listing. The permission confirmation module 306 uses the included identifiers to search the permission list and determine the permission level of the user account. The permission confirmation module 306 then returns the determined permission level in response to the request.

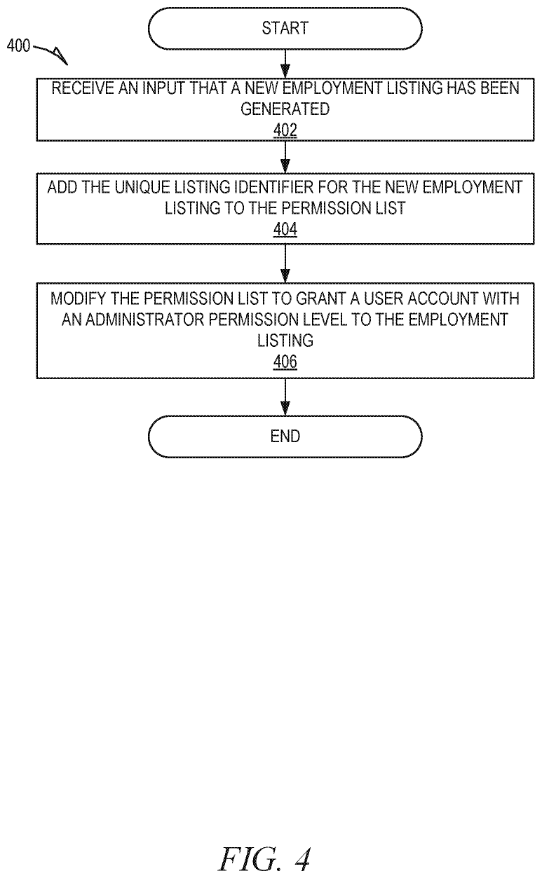

FIG. 4 is a flowchart showing an example method 400 of initializing permission levels for an employment listing, according to certain example embodiments. The method 400 may be embodied in computer readable instructions for execution by one or more processors such that the operations of the method 400 may be performed in part or in whole by the collaboration system 108; accordingly, the method 400 is described below by way of example with reference thereto. However, it shall be appreciated that at least some of the operations of the method 400 may be deployed on various other hardware configurations and the method 400 is not intended to be limited to the collaboration system 108.

At operation 402, the permission management module 202 receives an input that a new employment listing has been generated. For example, the permission management module 202 receives the input from the online service 106 as a result of a user generating the employment listing to be posted to the online service 106. The received input includes data identifying the generated employment listing (e.g., a unique listing identifier), the user account used to generate the employment listing (e.g., unique account identifier), and/or any permission levels selected by the generating user.

At operation 404, the permission initialization module 302 adds the unique listing identifier for the new employment listing to the permission list.

At operation 406, the permission initialization module 302 modifies the permission list to grant a user account with an administrator permission level to the employment listing. For example, the permission initialization module 302 adds the unique account identifier for the user account that generated the employment listing to the permission list and includes an associated value indicating that the user account ins granted administrator permission level. As another example, the permission initialization module 302 adds the unique account identifier for another user account that was designated during generation of the employment listing as being the administrator for the employment listing. The permission initialization module 302 also adds an associated value indicating that the user account ins granted administrator permission level.

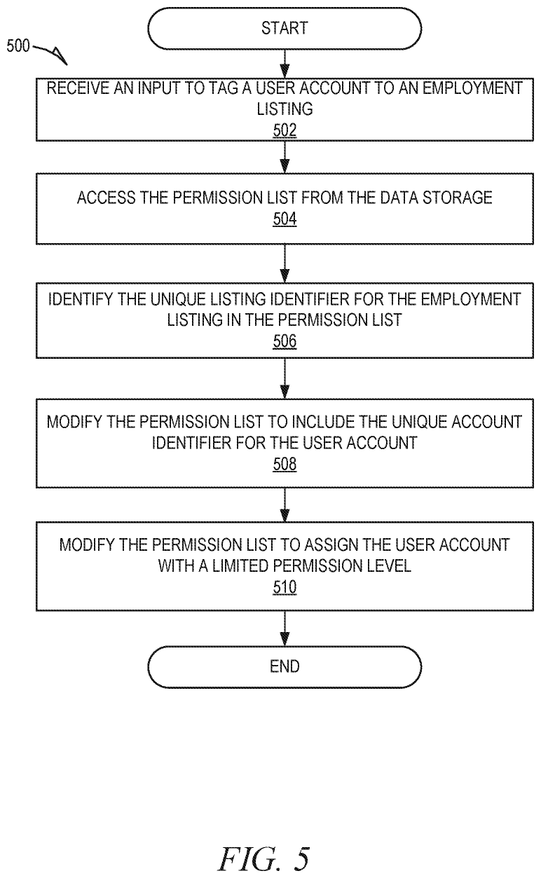

FIG. 5 is a flowchart showing an example method 500 of tagging a user account to an employment listing, according to certain example embodiments. The method 500 may be embodied in computer readable instructions for execution by one or more processors such that the operations of the method 500 may be performed in part or in whole by the collaboration system 108; accordingly, the method 500 is described below by way of example with reference thereto. However, it shall be appreciated that at least some of the operations of the method 500 may be deployed on various other hardware configurations and the method 500 is not intended to be limited to the collaboration system 108.

At operation 502, the permission management module 202 receives an input to tag a user account to an employment listing. The input may be received as a result of a request made by a user account that has an administrator permission level in relation to the employment listing. For example, the user that is granted administrator permission level to the employment listing uses their client device 102 to login to their user account with the online service and access the collaboration interface, which is used to request that the user account be tagged to the employment listing. The request includes data identifying the employment listing (e.g., unique listing identifier), the user account (e.g., unique account identifier), and the permission level and/or functions that the user account should be granted permission to perform.

At operation 504, the permission list modification module 304 accesses the permission list from the data storage 214.

At operation 506, the permission list modification module 304 identifies the unique listing identifier for the employment listing in the permission list. For example, the permission list modification module 304 searches the permission list based on the unique listing identifier included in the request.

At operation 508, the permission list modification module 304 modifies the permission list to include the unique account identifier for the user account. For example, the permission list modification module 304 modifies the permission list to include the unique account identifier received in the request.

At operation 510, the permission list modification module 304 modifies the permission list to assign the user account with a limited permission level. For example, the permission list modification module 304 modifies the permission list to add a value associated with the unique account identifier that indicates that the corresponding user account has a limited permission level. As another example, the permission list modification module 304 modifies the permission list to add values associated with the unique account identifier that identify the specific functions that the corresponding user account is granted permission to perform.

### Software Architecture

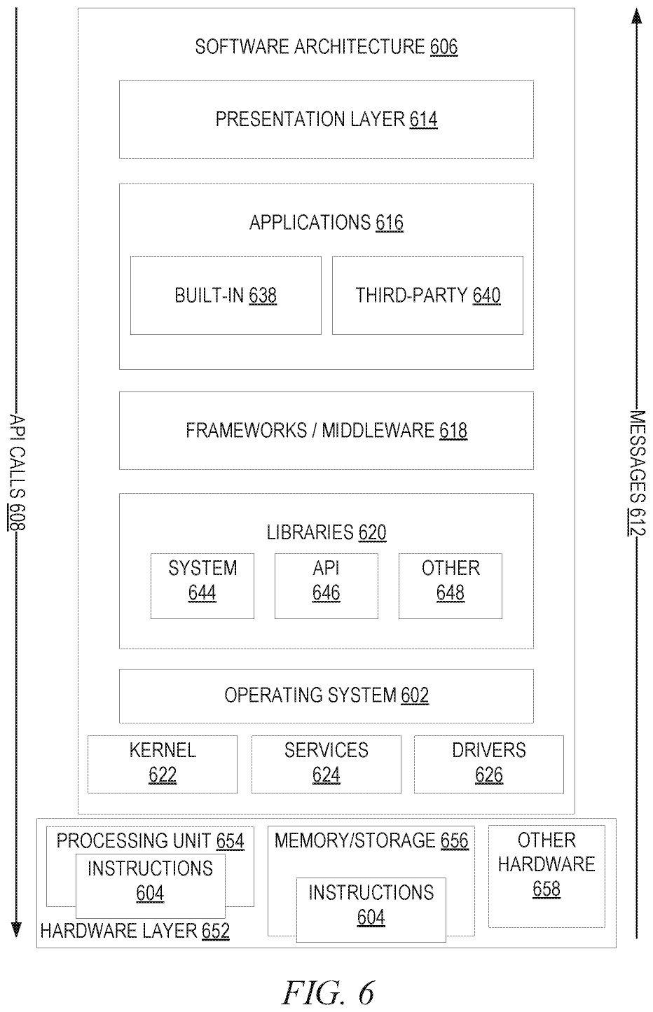

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
receiving a request to post a new employment listing to an online service, the request received from a client device logged into a first user account of the online service;
in response to receiving the request to post the new employment listing:
generating the employment listing, and
updating a permission list of the employment listing to provide the first user account with an administrator permission level in relation to the employment listing, the administrator permission level providing the first user account to perform at least a first function and a second function in relation to the employment listing;
receiving a request to tag a second user account of the online service to the employment listing;
in response to receiving the request to tag the second user account to the employment listing, updating the permission list of the employment listing to provide the second user account with a limited permission level in relation to the employment listing, the limited permission level providing the second user account with permission to perform the first function in relation to the employment listing, wherein the limited permission level does not provide the second user account with permission to perform the second function in relation to the employment listing.

2. The method of claim 1, further comprising:
receiving a request to tag a third user account of the online service to the employment listing;
in response to receiving the request to tag the third user account to the employment listing, updating the permission list of the employment listing to provide the third user account with the limited permission level in relation to the employment listing, the limited permission level providing the third user account with permission to perform the first function in relation to the employment listing, wherein the limited permission level does not provide the third user account with permission to perform the second function in relation to the employment listing.

3. The method of claim 1, wherein the first function is tagging user accounts to the employment listing.

4. The method of claim 1, wherein the second function is providing job insights for the employment listing.

5. The method of claim 1, wherein the second function is viewing user accounts added as candidates for the employment listing.

6. The method of claim 1, wherein the second function is providing feedback for a user account that has been added as a candidate for the employment listing.

7. The method of claim 1, further comprising:
initiating a communication session amongst a set of user accounts that are provided with either the administrator permission level or the limited permission level in relation to the employment listing, the communication session enabling each user account from the set of user accounts to transmit messages in the communication session that are received by other user accounts in the set of user accounts.

8. A system comprising:
one or more computer processors; and
one or more computer-readable mediums storing instructions that, when executed by the one or more compute processors, cause the system to perform operations comprising:
receiving a request to post a new employment listing to an online service, the request received from a client device logged into a first user account of the online service;
in response to receiving the request to post the new employment listing:
generating the employment listing, and
updating a permission list of the employment listing to provide the first user account with an administrator permission level in relation to the employment listing, the administrator permission level providing the first user account to perform at least a first function and a second function in relation to the employment listing;
receiving a request to tag a second user account of the online service to the employment listing;
in response to receiving the request to tag the second user account to the employment listing, updating the permission list of the employment listing to provide the second user account with a limited permission level in relation to the employment listing, the limited permission level providing the second user account with permission to perform the first function in relation to the employment listing, wherein the limited permission level does not provide the second user account with permission to perform the second function in relation to the employment listing.

9. The system of claim 8, the operations further comprising:
receiving a request to tag a third user account of the online service to the employment listing;
in response to receiving the request to tag the third user account to the employment listing, updating the permission list of the employment listing to provide the third user account with the limited permission level in relation to the employment listing, the limited permission level providing the third user account with permission to perform the first function in relation to the employment listing, wherein the limited permission level does not provide the third user account with permission to perform the second function in relation to the employment listing.

10. The system of claim 8, wherein the first function is tagging user accounts to the employment listing.

11. The system of claim 8, wherein the second function is providing job insights for the employment listing.

12. The system of claim 8, wherein the second function is viewing user accounts added as candidates for the employment listing.

13. The system of claim 8, wherein the second function is providing feedback for a user account that has been added as a candidate for the employment listing.

14. The system of claim 8, the operations further comprising:
initiating a communication session amongst a set of user accounts that are provided with either the administrator permission level or the limited permission level in relation to the employment listing, the communication session enabling each user account from the set of user accounts to transmit messages in the communication session that are received by other user accounts in the set of user accounts.

15. A non-transitory computer-readable medium storing instructions that, when executed by one or more compute processors of a computing system, cause the computing system to perform operations comprising:
receiving a request to post a new employment listing to an online service, the request received from a client device logged into a first user account of the online service;
in response to receiving the request to post the new employment listing:
generating the employment listing, and
updating a permission list of the employment listing to provide the first user account with an administrator permission level in relation to the employment listing, the administrator permission level providing the first user account to perform at least a first function and a second function in relation to the employment listing;
receiving a request to tag a second user account of the online service to the employment listing;
in response to receiving the request to tag the second user account to the employment listing, updating the permission list of the employment listing to provide the second user account with a limited permission level in relation to the employment listing, the limited permission level providing the second user account with permission to perform the first function in relation to the employment listing, wherein the limited permission level does not provide the second user account with permission to perform the second function in relation to the employment listing.

16. The non-transitory computer-readable medium of claim 15, the operations further comprising:
receiving a request to tag a third user account of the online service to the employment listing;
in response to receiving the request to tag the third user account to the employment listing, updating the permission list of the employment listing to provide the third user account with the limited permission level in relation to the employment listing, the limited permission level providing the third user account with permission to perform the first function in relation to the employment listing, wherein the limited permission level does not provide the third user account with permission to perform the second function in relation to the employment listing.

17. The non-transitory computer-readable medium of claim 15, wherein the first function is tagging user accounts to the employment listing.

18. The non-transitory computer-readable medium of claim 15, wherein the second function is providing job insights for the employment listing.

19. The non-transitory computer-readable medium of claim 15, wherein the second function is viewing user accounts added as candidates for the employment listing.

20. The non-transitory computer-readable medium of claim 15, the operations further comprising:
initiating a communication session amongst a set of user accounts that are provided with either the administrator permission level or the limited permission level in relation to the employment listing, the communication session enabling each user account from the set of user accounts to transmit messages in the communication session that are received by other user accounts in the set of user accounts.
